(19) United States
(12) Patent Application Publication
(10) Pub. No.: US 2026/0186864 A1
(43) Pub. Date: Jul. 2, 2026

(54) METHOD, SYSTEM, AND PROGRAM FOR DEADLOCK AVOIDANCE

(71) Applicant: Phoenix Software International, Inc., El Segundo, CA (US)

(72) Inventor: Thomas Alan Harper, Canton, GA (US)

(21) Appl. No.: 18/862,769

(22) PCT Filed: Aug. 20, 2024
(86) PCT No.: PCT/US2024/043098

§ 371 Date: Nov. 4, 2024

Related U.S. Application Data
(60) Provisional application No. 63/533,857, filed on Aug. 21, 2023.

(51) Int. Cl. G06F 9/52; G06F 9/46

(52) U.S. Cl. CPC G06F 9/524; G06F 9/466

(57) ABSTRACT

The present disclosure relates to systems, methods, processes, techniques, and computer program products to prevent deadlocks in a mainframe computing system through certain protocols in a lock request, contention exit, and notify exit routines.

### CROSS-REFERENCE TO RELATED APPLICATIONS

The present application claims priority to U.S. Provisional Application No. 63/533,857 filed on Aug. 21, 2023, which is incorporated herein by reference.

### FIELD

The present disclosure relates generally to computing resource deadlocks and lock and transaction management thereof through a transaction manager.

### BACKGROUND

As is known to persons skilled in the art, sysplex locking across multiple mainframe-type computing systems, for example, the well-known IBM SYSTEM Z platform and hardware provided by International Business Machines Corporation (“IBM”) located at New Orchard Road in Armonk, New York 10504, is accomplished by using a coupling facility lock structure in connection with the cross-system extended services (XES) component provided by IBM. However, such existing systems, methods, and computer program products do not prevent deadlocks, but only discover the existence of a deadlock later after a deadlock situation has occurred. Such discovery after the fact impacts performance negatively.

Some techniques to prevent deadlocks include hierarchy (sequencing) of lock requests, time-outs, or addressing deadlocks after they are detected (as previously mentioned). Hierarchy is not always possible in database applications. Time-outs may result in “innocent” transactions being canceled, e.g., transactions that would not result in a deadlock but are canceled anyway.

### SUMMARY

A method for preventing deadlocks in a computing system as described in the present disclosure.

A computer program product for preventing deadlocks in a computing system as described in the present disclosure.

A computing system for preventing deadlocks as described herein.

A method for preventing deadlocks in a mainframe computing system comprising: comprising invoking a lock request (LR) routine, by a computer processor, in response to a LR from a requesting transaction, wherein a LR includes a lock has value (LHV), and lock user data (LUD), wherein the LR routine includes determining whether contention exists between the requesting transaction and one or more other transactions. The method further includes invoking a contention exit (CE) routine, by the computer processor, in response to a determination that contention exists; wherein the CE routine includes: determining, by the computer processor, if the requesting transaction holds other locks. In response to an affirmative determination that the requesting transaction holds other locks, determining, by the computer processor, if the LR is a retry request by checking if a retry indicator is set. The CE routine further includes determining, by the computer processor, whether other lock contenders (LC) for the requested lock hold other locks. In response to an affirmative determination that the other LCs hold other locks, invoking, by the computer processor, a notify exit (NE) routine on each of the other LCs that hold other locks, wherein the NE routine includes: placing a most current LHV for each of the other LCs that hold other locks in a notify exit user data (NEUD) if a transaction for each of the other LCs has a LR that has a same LHV of a LHV of the LR from the requesting transaction and exiting the NE routine. The method further includes, upon exiting the NE routine, invoking, by the computer processor, the CE routine a second time, wherein the CE routine further includes: placing, by the computer processor, all LHVs from the NEUD in the LUD of the requesting transaction; determining, by the computer processor, if there are more LHVs than can fit in the LUD of the requesting transaction. In response to an affirmative determination that there are more LHVs than can fit in the LUD of the requesting transaction, setting an ambiguity indicator in the LUD, denying the LR, and exiting the CE routine. Upon exiting the CE routine for a second time, completing the LR routine, wherein the LR routine further includes: determining, by the computer processor, whether the ambiguity indicator in the LUD is set. In response to a determination that the ambiguity indicator in the LUD is not set, determining, by the computer processor, a match between a LHV the requesting transaction owns compared to the LHVs in the LUD of the requesting transaction. In response to a determination of a match, turning on the ambiguity indicator in the LUD, rolling back and retrying the transaction from a last syncpoint; and in response to a determination of no match, setting the retry indicator and reissuing the LR.

A computer program product for preventing deadlocks in a mainframe computing system, the computer program product is stored in a computer-readable storage medium, comprising program code that, when executed by the mainframe computing system, causes the computing system to perform actions comprising: invoking a lock request (LR) routine, by a computer processor. In response to a LR from a requesting transaction, wherein a LR includes a lock has value (LHV), and lock user data (LUD), wherein the LR routine includes determining whether contention exists between the requesting transaction and one or more other transactions. Additional actions including: invoking a contention exit (CE) routine, by the computer processor, in response to a determination that contention exists; wherein the CE routine includes: determining, by the computer processor, if the requesting transaction holds other locks. In response to an affirmative determination that the requesting transaction holds other locks, determining, by the computer processor, if the LR is a retry request by checking if a retry indicator is set. Further actions include: determining, by the computer processor, whether other lock contenders (LC) for the requested lock hold other locks. In response to an affirmative determination that the other LCs hold other locks, invoking, by the computer processor, a notify exit (NE) routine on each of the other LCs that hold other locks, wherein the NE routine includes: placing a most current LHV for each of the other LCs that hold other locks in a notify exit user data (NEUD) if a transaction for each of the other LCs has a LR that has a same LHV of a LHV of the LR from the requesting transaction and exiting the NE routine. Upon exiting the NE routine, invoking, by the computer processor, the CE routine a second time, wherein the CE routine further includes: placing, by the computer processor, all LHVs from the NEUD in the LUD of the requesting transaction. The CE routine further includes determining, by the computer processor, if there are more LHVs than can fit in the LUD of the requesting transaction. In response to an affirmative determination that there are more LHVs than can fit in the LUD of the requesting transaction, setting an ambiguity indicator in the LUD, denying the LR, and exiting the CE routine. Upon exiting the CE routine for a second time, completing the LR routine, wherein the LR routine further includes: determining, by the computer processor, whether the ambiguity indicator in the LUD is set. In response to a determination that the ambiguity indicator in the LUD is not set, determining, by the computer processor, a match between a LHV the requesting transaction owns compared to the LHVs in the LUD of the requesting transaction. In response to a determination of a match, turning on the ambiguity indicator in the LUD, rolling back and retrying the transaction from a last syncpoint; and in response to a determination of no match, setting the retry indicator and reissuing the LR.

A deadlock prevention system comprising: one or more processors; one or more computer-readable storage media operably coupled to at least one of the processors; and program instructions stored on the one or more computer-readable storage media for execution by at least one of the processors to cause the deadlock prevention system to perform the actions of: invoking a lock request (LR) routine, by at least one of the processors, in response to a LR from a requesting transaction, wherein a LR includes a lock has value (LHV), and lock user data (LUD). Wherein the LR routine includes determining whether contention exists between the requesting transaction and one or more other transactions. Additional actions include invoking a contention exit (CE) routine, by at least one of the processors, in response to a determination that contention exists; wherein the CE routine includes: determining, by at least one of the processors, if the requesting transaction holds other locks. In response to an affirmative determination that the requesting transaction holds other locks, determining, by at least one of the processors, if the LR is a retry request by checking if a retry indicator is set. Determining, by at least one of the processors, whether other lock contenders (LC) for the requested lock hold other locks. In response to an affirmative determination that the other LCs hold other locks, invoking, by at least one of the processors, a notify exit (NE) routine on each of the other LCs that hold other locks, wherein the NE routine includes: placing a most current LHV for each of the other LCs that hold other locks in a notify exit user data (NEUD) if a transaction for each of the other LCs has a LR that has a same LHV of a LHV of the LR from the requesting transaction, and exiting the NE routine. Upon exiting the NE routine, invoking, by at least one of the processors, the CE routine a second time, wherein the CE routine further includes: placing, by at least one of the processors, all LHVs from the NEUD in the LUD of the requesting transaction. The CE routine further includes determining, by at least one of the processors, if there are more LHVs than can fit in the LUD of the requesting transaction. In response to an affirmative determination that there are more LHVs than can fit in the LUD of the requesting transaction, setting an ambiguity indicator in the LUD, denying the LR, and exiting the CE routine. Upon exiting the CE routine for a second time, completing the LR routine, wherein the LR routine further includes: determining, by at least one of the processors, whether the ambiguity indicator in the LUD is set. In response to a determination that the ambiguity indicator in the LUD is not set, determining, by at least one of the processors, a match between a LHV the requesting transaction owns compared to the LHVs in the LUD of the requesting transaction. In response to a determination of a match, turning on the ambiguity indicator in the LUD, rolling back and retrying the transaction from a last syncpoint; and in response to a determination of no match, setting the retry indicator and reissuing the LR.

### BRIEF DESCRIPTION OF THE DRAWINGS

The drawings included with this application illustrate certain aspects of the computing systems, methods, and computer program products described herein. However, the drawings should not be viewed as exclusive embodiments or limiting. The subject matter disclosed is capable of modification or alteration in form and function, as will occur to those skilled in the art with the benefit of this disclosure.

FIG. 1 is a depiction representative of a classic deadlock

FIG. 2 is an exemplary depiction of coupling facility and application instances showing contention exit and notify exit routines.

FIG. 3 is an example logical flow diagram illustrating the beginning of a lock request routine.

FIG. 4 is an example logical flow diagram illustrating a contention exit routine.

FIG. 5 is an example logical flow diagram illustrating a notify exit routine.

FIG. 6 is an example logical flow diagram of a contention exit routine following the notify exit routine of FIG. 5.

FIG. 7 is an example logical flow diagram illustrating the completion of the lock request routine.

FIGS. 8A-8C illustrate an example flow diagram for deadlock avoidance.

FIG. 9 is a diagram for a computing system 1000 suitable for implementing and performing the methods and techniques as described herein on a computer.

### DETAILED DESCRIPTION

The system, method, process, technique, and computer program product described in the present disclosure address the problems enterprises encounter relating to deadlocks in computing resources. The system, method, process, technique, and computer program product described herein utilizes the coupling facility (CF) provided contention exit (CE) and notify exit (NE) routines. The lock request (LR), CE, and NE routines are configured with the presently described protocols, processes, and techniques to prevent deadlocks from occurring.

As is known by persons skilled in the art, there are two types of locks, a shared lock and an exclusive lock. A shared lock enables the reading of a resource and ensures that a record is not in the process of being updated during a read-only request. Shared locks may be owned by several transactions at the same time. An exclusive lock enables both reading and writing to a resource. An exclusive lock can only be owned by one transaction at a time.

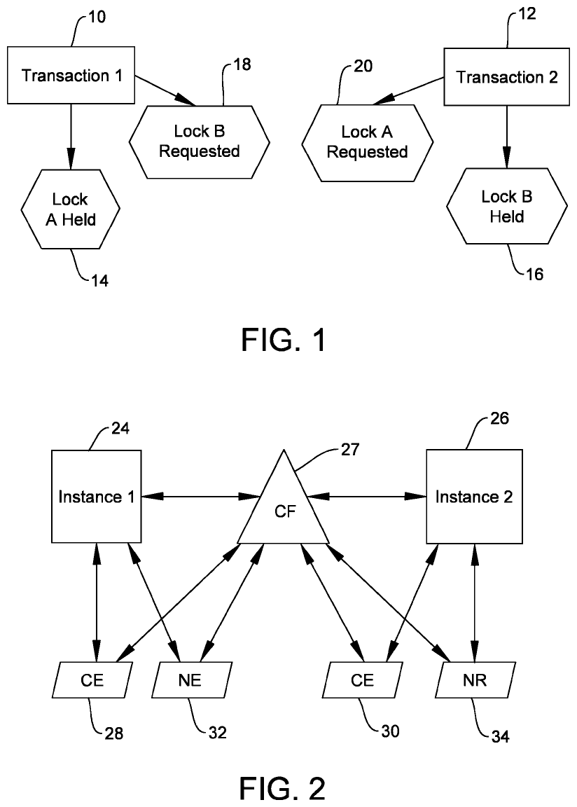

FIG. 1 illustrates a classic deadlock situation. As illustrated in FIG. 1, transaction 1 (10) and transaction 2 (12) are utilizing resources A and B, respectively. Accordingly, transactions 1 and 2 are holding locks A (14) and B (16), respectively. Transaction 1 requests lock B (18) and transaction 2 requests lock A (20), thereby resulting in an unresolved contention for the requested resources.

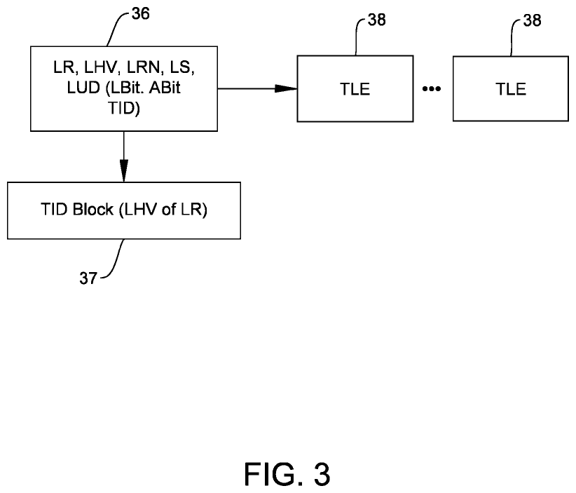

An example is illustrated in FIG. 2. In an IBM System Z, sysplex-wide locks are implemented with a CF lock structure (27), unique for each application. When starting, application instances (24, 26) connect to a CF lock structure (27), and provide a number of exits, for example, CE (28, 30) and NE (32, 34).

Transactions executing in each instance make LRs from time-to-time. Lock requests include a lock hash value (LIIV), a lock resource name (LRN), a lock status (LS), and lock user data (LUD).

For ease of discussion, reference to the figures in connection with the presently disclosed deadlock avoidance techniques will be described. Whenever a LR is made, certain information is added to the LUD. Specifically, a flag bit called the Lock Bit (LBit), another flag bit called the Retry Bit (RBit), a third bit called the Ambiguity Bit (ABit), and a unique Transaction ID (TID).

The LBit provides an indication of whether or not the present LR from the given transaction, i.e., requesting the transaction, already owns other locks. The LBit is set to on if the present LR from the requesting transaction owns other locks and is set to off if it does not. Such configuration provides a performance enhancement over existing deadlock avoidance systems and methodologies.

The RBit indicates if the present LR is being issued for the retry (as will be discussed later). The ABit provides an indication of ambiguity about a deadlock (DL). The TID is the unique identifier associated with each given transaction.

Each transaction maintains a list of its currently-owned locks called the Transaction Lock List (TLL). Each entry in the TLL is called a Transaction Lock Entry (TLE). Each TLE includes certain information corresponding to its currently owned locks, including the LHV, LRN, and LS. The LR routine is configured such that a TLE is added to its TLL when the requested lock is granted.

When a transaction issues a new LR, the CF code is configured to take one of the following actions: (i) grant the request, which is when the TLE is added to the TLL; or (ii) drive a CE routine on one of the connected users. When the CE routine is driven, this is treated as a new LR, and applicable information is provided corresponding to this new request for processing in the CE routine.

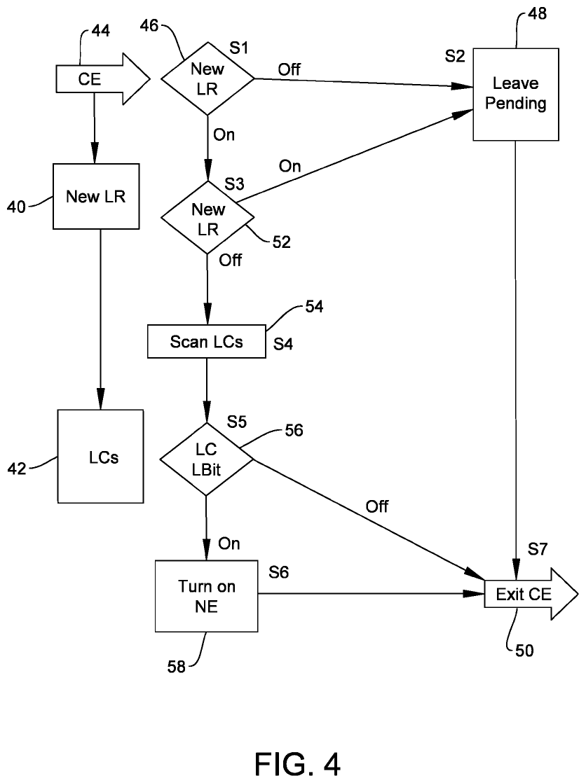

The above is graphically illustrated in FIG. 3, which shows the LR start for a new lock request. Data Structures present are shown in elements (36 and 37) and the TLE added to TLL is shown in elements (38).

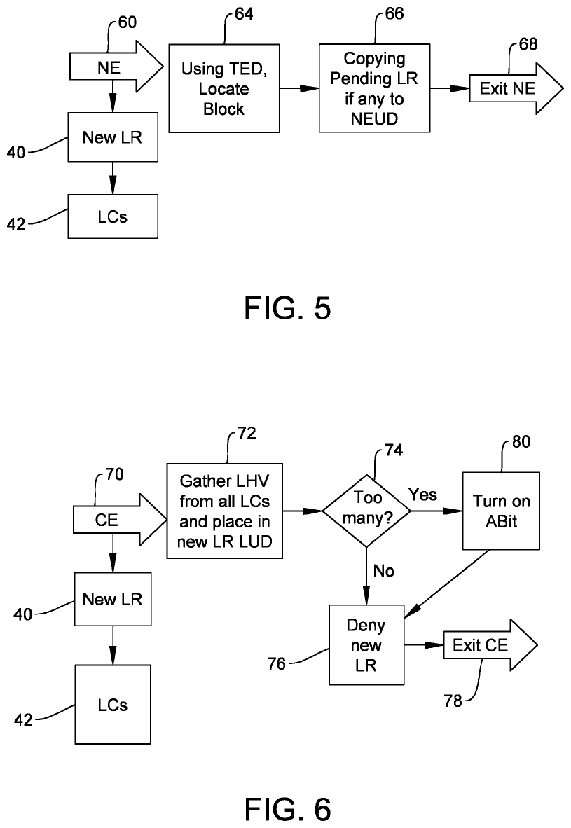

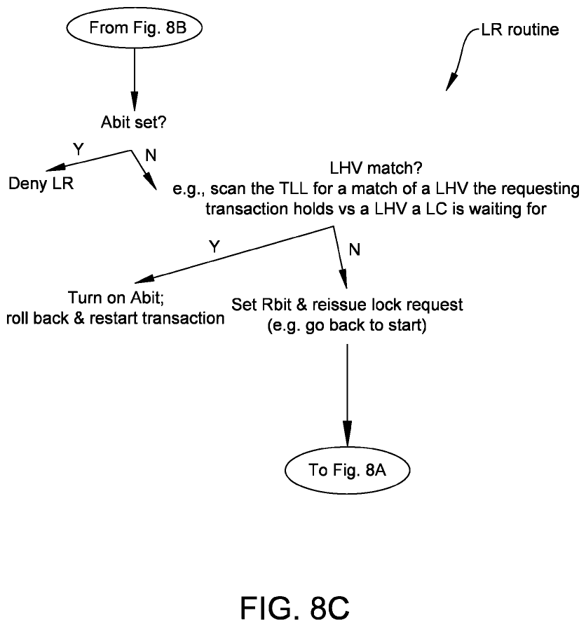

FIGS. 4 and 8A illustrate a CE routine to prevent deadlocks. Control blocks are provided by XES which represent the new LR (40), as well as a list of control blocks representing current lock holders and lock contenders (LCs) (as illustrated along the left side of FIG. 4 as LCs (42)). The list includes locks that have been granted and those that are pending. The CE routine (44) is configured to: (i) grant the lock request; (ii) deny the request; (iii) keep the request pending; (iv) regrant the request; and (v) request execution of the NE routine for selected LCs.

At S1 (46) of FIG. 4, a determination is made if the LBit of the present LR is on. If the LBit is off, meaning that no locks are held, then the present LR cannot cause a deadlock. Accordingly, the routine proceeds to S2 (48) to keep the request as pending, and the CE routine is then exited as depicted by S7 (50). If the LBit of the present LR is on, then the RBit is checked at S3 (52) to determine if the present LR is representative of a retry request. If the RBit of the present LR is on, meaning this LR is a retry request, then the routine keeps the request pending (S2 (48)) and then exits the CE routine (S7 (50)).

If, at S3 (52), the RBit is off, meaning that this is the first LR, i.e., not a retry, for the requesting transaction, then the routine proceeds to S4 (54) and S5 (56) to scan all other LCs and check the LBit in the LUD of those other LCs is set to on, i.e., indicating whether the other LCs for the requested lock hold any other locks prior to their current respective LR. For all LCs that do hold other locks, then those LCs are requested to have their NEs be driven, e.g., by setting a bit to drive the NE for those LCs, as depicted in S6 (58), and then the CE routine is exited. If the LBit for the other LCs at S5 (56) is off, then the CE is exited. As will be discussed later, the CE routine will be driven again when the NE routine for each of the applicable LCs has completed.

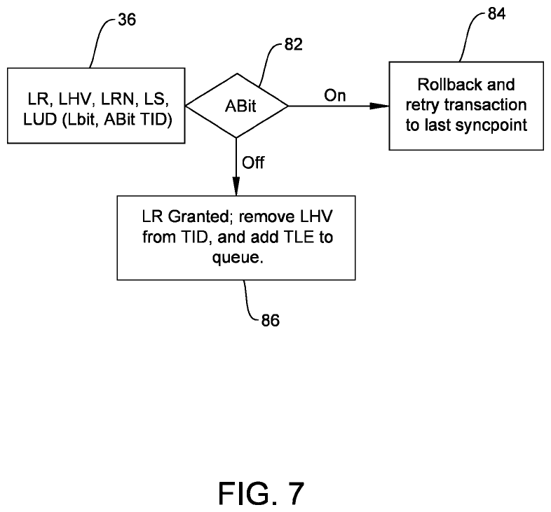

The deadlock prevention process proceeds to the NE routine 60, depicted in FIGS. 5 and 8B. As will be described, the LHVs that the applicable LCs are gathered in order to determine if the requesting transaction for the present LR (40) owns a lock that one of the LCs (42) wants (or has requested).

The process proceeds to gather all the LHVs from each of the LCs (42) for the requested lock that hold other locks. This is accomplished by providing in the NEUD the LHV from the requesting CE. The TID contained in the NEUD is copied from the original/present LR (of the requesting transaction) and is used to locate the TID anchor of the transaction (64). When the TID anchor is located, it is determined via the current transaction TID the most recent (via timestamp) LHV requested, if non-zero. If the transaction for each of the LC has another (not the same as the pending LHV from the CE) pending LR represented by this LHV, then the LHV is placed in the NEUD (66), and the NE is exited (68). Stated differently, the NE routine is gathering the most recent LHV of each of the LCs other than the LHV of the requested lock, and that gathered LHV has the same value of the LHV of the requested lock.

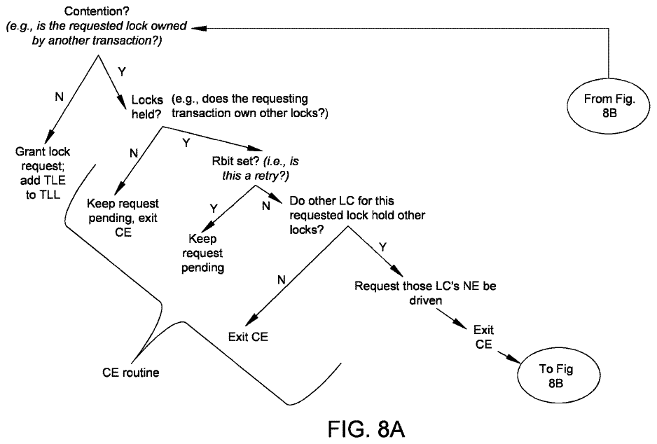

Once all the NE processes for each of the LCs are complete, the process drives the CE again. Exemplary illustrations of the CE routine (70) driven again are in FIGS. 6 and 8B. All the LHVs that were gathered from the LCs (42) are placed in the LUD of the requesting transaction (72). As many LHVs as possible are placed in the LUD due to the space limitations of the LUD. For example, the LUD has 64 bytes for placement of the LHVs.

Next, a determination is made as to whether there are more LHVs than can fit (74), and if not, meaning there is not enough space in the LUD, the LR is denied (76) and the CE is exited (78). If there are more LHVs than can fit in the LUD, meaning that a potential deadlock is possible but not known with certainty, the Abit in the LUD is turned on (80) in order to prevent the possibility of a retry. The LR is then denied (76) and the CE is exited (78).

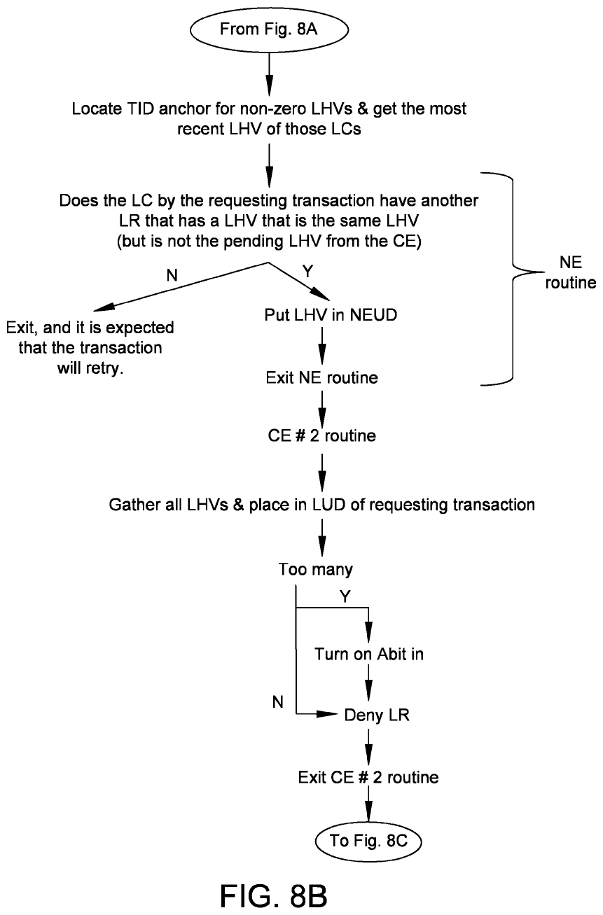

Next, referring to FIGS. 7 and 8C, a determination is made if the Abit is set (82). If it is, then the LR is denied. If the Abit is not set, then the process proceeds to determine if there is a match for a LHV that the requesting transaction holds by scanning its TLL and comparing it to the gathered list of LHVs that a LC is waiting for, which was gathered previously as described above. If there is a match, meaning that the present LR of the requesting transaction would cause a DL, the Abit is turned on and the transaction is rolled back to the last syncpoint and restarted (84). If determined that there is not a match, then the present LR cannot cause a DL and Rbit is set to on and the request is reissued, meaning that the next iteration will be a retry request.

The process then proceeds back to determine if contention exists, e.g., the requested lock is owned by another transaction as depicted in FIGS. 8A and 8C.

If the CE is not driven again for a third time, meaning that no DL is possible, the following may occur: upon the reissuance of the LR that the requested lock is not owned by another transaction, the LR is granted and the TLE is added to the TLL (86); or that the requesting transaction does not own any other locks, then the request is kept pending; or that since this is a retry request (i.e. Rbit is set), the request is kept pending.

If the CE is driven for a third time, it is possible that a contention exists, but it is not caused by the pending LR and so the LR is kept pending and the CE is exited. For example, this may occur in a situation where the LR is in contention for a lock which is not a DL situation, where another transaction may own a lock exclusive, and the new lock requestor is requesting a shared lock-in such case, the request is kept ending until the exclusive lock is released.

It is possible present disclosure may deny a new LR when a deadlock would not have occurred, for example, on the rare occurrence that the LHV for two different LRNs are the same. However, such scenario is far less common than other deadlock detection processes and techniques that cancel or deny innocent transactions, i.e., denial of a transaction's lock request when a deadlock would not occur.

The present disclosure prevents deadlocks rather than detects deadlocks after the fact. The exemplary system, method, process, techniques, and computer program product described herein for preventing deadlocks on an IBM System Z mainframe computer system with a CF. The exemplary disclosure is made in reference with such computing system using a z/OS operating system. Suitable programming languages are envisioned, including high-level assembler. z/OS version 2 release 4, “MVS Programming: Sysplex Services Guide”, IBM Publication No. SA 23-1400-40, September 2020 is incorporated by reference herein in its entirety. Modifications can be made to the present disclosure to achieve the functionality described herein to be suitable for other types of computer systems, devices, operating systems, and the like.

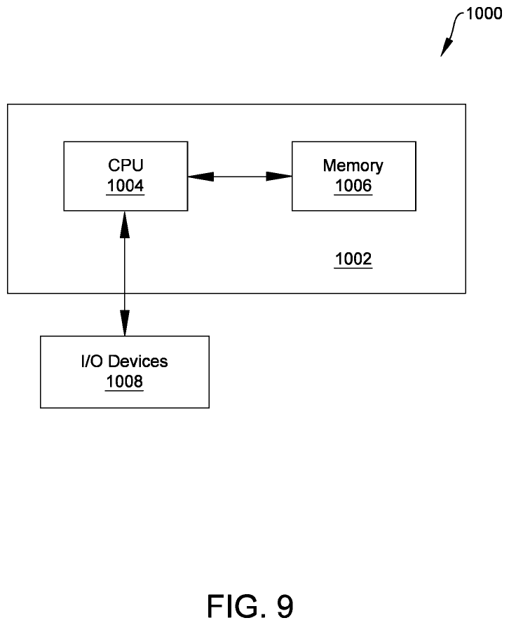

For example, an IBM System Z mainframe computing system is suitable for implementing and performing the methods, techniques, processes, and executing the computer program products, instructions, and/or components described herein. With reference to FIG. 9, computing systems 1000 may include one or more computing devices 1002 of the same or different types, and each one or more computing devices may be operably connected to one or more input/output (I/O) devices 1008.

Computing system 1000 may include central processing unit (CPU) 1004. CPU 1004 includes one or more processors reading and/or executing instructions, programs, or applications stored therein or stored in memory 1006 and/or computer-readable storage media of I/O devices 1008 and accessing and/or storing data in memory 1006 and/or computer-readable storage media of I/O devices 1008. CPU 1004 is operably connected with memory 1006. CPU 1004 is also operably connected with I/O devices 1008 through an applicable interface component for the corresponding I/O device 1008, e.g., port (serial, parallel USB), wire, card (sound, video, network), or the like. Exemplary types of CPU 1004 may include general-purpose processors, digital programmable devices, microcontrollers, digital signal processors (DSPs), application specific integrated circuit (ASIC), and field programmable gate array (FPGA), or other components and combinations thereof designed to perform the functions described herein. Memory 1006 includes data storage, volatile memory, e.g., random access memory (RAM), and non-volatile memory, e.g., read only memory (ROM) or non-volatile RAM (NVRAM).

Computing system may operate in a networked environment using connections to remote computing devices and computing systems through a network, such as a local area network (LAN), wide area network (WAN), peer-to-peer networks, grid computing infrastructures, the Internet, and other network types known in the art. I/O devices 1008 include various devices that a user may use to interact with computing system or computing device. Non-limiting representative examples of I/O devices 1008 include a dummy terminal, keyboards, touchscreens, mouse, and other pointing devices; a visual display device, such as a cathode ray tube, liquid crystal display, screens, touch screens, and other suitable display devices for visually communicating and interacting with the user; audio devices, such as a microphone, headphones, speakers; and print devices for printing, scanning, faxing, and/or transmitting data and images. I/O devices 1008 may also include computer-readable storage media, e.g., mass storage devices, disks, magnetic disks, optical disks, magnetic tape, flash memory, RAM, ROM, EEPROM, or any other media that can be used to carry or store computer-readable information. I/O devices 1008 may also include a communication device for connecting computing system 1000 with one or more other computing systems over a network, e.g., wired and/or wirelessly, utilizing one or more communications protocols, e.g., IEEE 802.11, IEEE 802.3, TCP/IP, cellular protocols, any other communications protocols, and combinations thereof. Computing systems may each include one or more communication devices and applicable controller(s) for connecting such computing systems or computing devices with one or more other computing systems and/or computing devices, such that I/O devices are integral with and are part of a computing system or computing device and not a separate component therefrom, e.g., built-in cameras, microphones, speakers, network connection devices, and other built-in components.

Computing systems may include one or more I/O devices of the same type or of different types and combinations thereof and one or more computing devices of the same type or of different types and combinations thereof operably connected to each other.

The functions, methods, or algorithms described herein may be implemented in hardware, software, and combinations thereof. For example, when implanted in software, the software may be application software, operating system software, firmware, middleware, or any combinations thereof. When implemented in software, the described methods, processes, and techniques may be stored in memory, computer-readable storage media, and/or combinations thereof and transmitted as one or more instructions or code to cause one or more computing systems to operate in accordance with the teachings of the present disclosure. The operable connection of the various components of the computing system includes buses, circuitry, wires, wireless, or other connections. The functions, methods, and techniques described herein may be implemented by one or more computing system in cooperation with each other. The components of the computing system described, including their relationships and functions, are exemplary and are not to limit the implementation of the system, method, techniques, and computer program product described herein.

The following numbered cases represent examples of methods, products, and systems according to this disclosure.
Case 1: A method for preventing deadlocks in a computing system as described in the present disclosure.
Case 2: A computer program product for preventing deadlocks in a computing system as described in the present disclosure.
Case 3: A computing system for preventing deadlocks as described herein.
Case 4: A method for preventing deadlocks in a mainframe computing system comprising:
   invoking a lock request (LR) routine, by a computer processor, in response to a LR from a requesting transaction, wherein a LR includes a lock has value (LHV), and lock user data (LUD), wherein the LR routine includes determining whether contention exists between the requesting transaction and one or more other transactions;
   invoking a contention exit (CE) routine, by the computer processor, in response to a determination that contention exists; wherein the CE routine includes:
      determining, by the computer processor, if the requesting transaction holds other locks;
      in response to an affirmative determination that the requesting transaction holds other locks, determining, by the computer processor, if the LR is a retry request by checking if a retry indicator is set;
      determining, by the computer processor, whether other lock contenders (LC) for the requested lock hold other locks; and
      in response to an affirmative determination that the other LCs hold other locks, invoking, by the computer processor, a notify exit (NE) routine on each of the other LCs that hold other locks, wherein the NE routine includes:
         placing a most current LHV for each of the other LCs that hold other locks in a notify exit user data (NEUD) if a transaction for each of the other LCs has a LR that has a same LHV of a LHV of the LR from the requesting transaction, and exiting the NE routine;
   upon exiting the NE routine, invoking, by the computer processor, the CE routine a second time, wherein the CE routine further includes:
      placing, by the computer processor, all LHVs from the NEUD in the LUD of the requesting transaction;
      determining, by the computer processor, if there are more LHVs than can fit in the LUD of the requesting transaction; and
      in response to an affirmative determination that there are more LHVs than can fit in the LUD of the requesting transaction, setting an ambiguity indicator in the LUD, denying the LR, and exiting the CE routine; and
   upon exiting the CE routine for a second time, completing the LR routine, wherein the LR routine further includes:
      determining, by the computer processor, whether the ambiguity indicator in the LUD is set;
      in response to a determination that the ambiguity indicator in the LUD is not set, determining, by the computer processor, a match between a LHV the requesting transaction owns compared to the LHVs in the LUD of the requesting transaction;
      in response to a determination of a match, turning on the ambiguity indicator in the LUD, rolling back and retrying the transaction from a last syncpoint; and
      in response to a determination of no match, setting the retry indicator and reissuing the LR.
Case 5: The method of Case 4, wherein the LR further includes a lock resource name (LRN), and a lock status (LS).
Case 6: The method of either Case 4 or Case 5, wherein the CE routine further includes: in response to a determination that the requesting transaction does not hold other locks, keeping the LR pending and exiting the CE routine.
Case 7: The method of any of Cases 4 to 6, wherein the CE routine further includes: in response to a determination the LR is not a retry request, keeping the LR pending, and exiting the CE routine.
Case 8: The method of any of Cases 4 to 7, wherein reissuing the LR restarts the LR routine.
Case 9: A computer program product for preventing deadlocks in a mainframe computing system, the computer program product stored in a computer-readable storage medium, comprising program code that, when executed by the mainframe computing system, causes the computing system to perform actions comprising:
   invoking a lock request (LR) routine, by a computer processor, in response to a LR from a requesting transaction, wherein a LR includes a lock has value (LHV), and lock user data (LUD), wherein the LR routine includes determining whether contention exists between the requesting transaction and one or more other transactions;
   invoking a contention exit (CE) routine, by the computer processor, in response to a determination that contention exists; wherein the CE routine includes:
      determining, by the computer processor, if the requesting transaction holds other locks;
      in response to an affirmative determination that the requesting transaction holds other locks, determining, by the computer processor, if the LR is a retry request by checking if a retry indicator is set;
      determining, by the computer processor, whether other lock contenders (LC) for the requested lock hold other locks; and
      in response to an affirmative determination that the other LCs hold other locks, invoking, by the computer processor, a notify exit (NE) routine on each of the other LCs that hold other locks, wherein the NE routine includes:
         placing a most current LHV for each of the other LCs that hold other locks in a notify exit user data (NEUD) if a transaction for each of the other LCs has a LR that has a same LHV of a LHV of the LR from the requesting transaction, and exiting the NE routine;
   upon exiting the NE routine, invoking, by the computer processor, the CE routine a second time, wherein the CE routine further includes:
      placing, by the computer processor, all LHVs from the NEUD in the LUD of the requesting transaction;
      determining, by the computer processor, if there are more LHVs than can fit in the LUD of the requesting transaction; and
      in response to an affirmative determination that there are more LHVs than can fit in the LUD of the requesting transaction, setting an ambiguity indicator in the LUD, denying the LR, and exiting the CE routine; and
   upon exiting the CE routine for a second time, completing the LR routine, wherein the LR routine further includes:
      determining, by the computer processor, whether the ambiguity indicator in the LUD is set;
      in response to a determination that the ambiguity indicator in the LUD is not set, determining, by the computer processor, a match between a LHV the requesting transaction owns compared to the LHVs in the LUD of the requesting transaction;
      in response to a determination of a match, turning on the ambiguity indicator in the LUD, rolling back and retrying the transaction from a last syncpoint; and
      in response to a determination of no match, setting the retry indicator and reissuing the LR.
Case 10: The computer program product of Case 9, wherein the LR further includes a lock resource name (LRN), and a lock status (LS).
Case 11: The computer program product of either Case 9 or Case 10, wherein the CE routine further includes: in response to a determination that the requesting transaction does not hold other locks, keeping the LR pending and exiting the CE routine.
Case 12: The computer program product of any of Cases 9 to 11, wherein the CE routine further includes: in response to a determination the LR is not a retry request, keeping the LR pending and exiting the CE routine.
Case 13: The computer program product of any of Cases 9 to 12, wherein reissuing the LR restarts the LR routine.
Case 14: A deadlock prevention system comprising:
   one or more processors;
   one or more computer-readable storage media operably coupled to at least one of the processors; and
   program instructions stored on the one or more computer-readable storage media for execution by at least one of the processors to cause the deadlock prevention system to perform the actions of:
      invoking a lock request (LR) routine, by at least one of the processors, in response to a LR from a requesting transaction, wherein a LR includes a lock has value (LHV), and lock user data (LUD), wherein the LR routine includes determining whether contention exists between the requesting transaction and one or more other transactions;
      invoking a contention exit (CE) routine, by at least one of the processors, in response to a determination that contention exists; wherein the CE routine includes:
         determining, by at least one of the processors, if the requesting transaction holds other locks;
         in response to an affirmative determination that the requesting transaction holds other locks, determining, by at least one of the processors, if the LR is a retry request by checking if a retry indicator is set;
         determining, by at least one of the processors, whether other lock contenders (LC) for the requested lock hold other locks; and
         in response to an affirmative determination that the other LCs hold other locks, invoking, by at least one of the processors, a notify exit (NE) routine on each of the other LCs that hold other locks, wherein the NE routine includes:
         placing a most current LHV for each of the other LCs that hold other locks in a notify exit user data (NEUD) if a transaction for each of the other LCs has a LR that has a same LHV of a LHV of the LR from the requesting transaction, and exiting the NE routine;
   upon exiting the NE routine, invoking, by at least one of the processors, the CE routine a second time, wherein the CE routine further includes:
      placing, by at least one of the processors, all LHVs from the NEUD in the LUD of the requesting transaction;
      determining, by at least one of the processors, if there are more LHVs than can fit in the LUD of the requesting transaction; and
      in response to an affirmative determination that there are more LHVs than can fit in the LUD of the requesting transaction, setting an ambiguity indicator in the LUD, denying the LR, and exiting the CE routine; and
   upon exiting the CE routine for a second time, completing the LR routine, wherein the LR routine further includes:
      determining, by at least one of the processors, whether the ambiguity indicator in the LUD is set;
      in response to a determination that the ambiguity indicator in the LUD is not set, determining, by at least one of the processors, a match between a LHV the requesting transaction owns compared to the LHVs in the LUD of the requesting transaction;
      in response to a determination of a match, turning on the ambiguity indicator in the LUD, rolling back and retrying the transaction from a last syncpoint; and
      in response to a determination of no match, setting the retry indicator and reissuing the LR.
Case 15: The system of Case 14, wherein the LR further includes a lock resource name (LRN), and a lock status (LS).
Case 16: The system of either Case 14 or Case 15, wherein the CE routine further includes: in response to a determination that the requesting transaction does not hold other locks, keeping the LR pending and exiting the CE routine.
Case 17: The system of any of Cases 14 to 16, wherein the CE routine further includes: in response to a determination the LR is not a retry request, keeping the LR pending and exiting the CE routine.
Case 18: The system of any of Cases 14 to 17, wherein reissuing the LR restarts the LR routine.

To the extent various third-party software and components are referenced in the present disclosure, such is exemplary and for ease of discussion and readability. The present system, method, and computer program product are not limited to such components or software applications, and components and applications capable of performing similar functions to those described herein to achieve the results described herein are likewise suitable.

The use of ordinal number terminology (i.e., “first,” “second,” “third,” “fourth,” etc.) is for the purpose of differentiating between two or more items and is not meant to imply any sequence or order or importance to one item over another or any order of addition. The term “or combinations thereof” as used herein refers to all permutations and combinations of the listed items preceding the term. The skilled artisan will understand that typically there is no limit on the number of items or terms in any combination, unless otherwise apparent from the context. The use of the term “or” in the claims is used to mean “and/or” unless explicitly indicated to refer to alternatives only or the alternatives are mutually exclusive, although the disclosure supports a definition that refers to only alternatives and “and/or.”

The use of the word “a” or “an” when used in conjunction with the term “comprising” in the claims and/or the specification may mean “one,” but it is also consistent with the meaning of “one or more,” “at least one,” and “one or more than one.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Although certain steps are described herein and illustrated in the figures as occurring sequentially, some steps may occur simultaneously with each other or in an order that is not depicted. While various implementations have been described herein, such descriptions are presented by way of example and are not to be limited to the precise descriptions and illustrations. Accordingly, numerous modifications and variations are possible by those skilled in the art without departing from the spirit and scope hereof, as defined by the following and later-submitted claims and their equivalents. The breadth and scope of the present disclosure should not be limited by any of the implementations and illustrations described herein but should be defined only in accordance with the following and later-submitted claims and their equivalents.

What is claimed is:

1. A method for preventing deadlocks in a mainframe computing system comprising:
invoking a lock request (LR) routine, by a computer processor, in response to a LR from a requesting transaction, wherein a LR includes a lock has value (LHV), and lock user data (LUD), wherein the LR routine includes determining whether contention exists between the requesting transaction and one or more other transactions;
invoking a contention exit (CE) routine, by the computer processor, in response to a determination that contention exists; wherein the CE routine includes:
determining, by the computer processor, if the requesting transaction holds other locks;
in response to an affirmative determination that the requesting transaction holds other locks, determining, by the computer processor, if the LR is a retry request by checking if a retry indicator is set;
determining, by the computer processor, whether other lock contenders (LC) for the requested lock hold other locks; and
in response to an affirmative determination that the other LCs hold other locks, invoking, by the computer processor, a notify exit (NE) routine on each of the other LCs that hold other locks, wherein the NE routine includes:
placing a most current LHV for each of the other LCs that hold other locks in a notify exit user data (NEUD) if a transaction for each of the other LCs has a LR that has a same LHV of a LHV of the LR from the requesting transaction, and exiting the NE routine;
upon exiting the NE routine, invoking, by the computer processor, the CE routine a second time, wherein the CE routine further includes:
placing, by the computer processor, all LHVs from the NEUD in the LUD of the requesting transaction;
determining, by the computer processor, if there are more LHVs than can fit in the LUD of the requesting transaction; and
in response to an affirmative determination that there are more LHVs than can fit in the LUD of the requesting transaction, setting an ambiguity indicator in the LUD, denying the LR, and exiting the CE routine; and
upon exiting the CE routine for a second time, completing the LR routine, wherein the LR routine further includes:
determining, by the computer processor, whether the ambiguity indicator in the LUD is set;
in response to a determination that the ambiguity indicator in the LUD is not set, determining, by the computer processor, a match between a LHV the requesting transaction owns compared to the LHVs in the LUD of the requesting transaction;
in response to a determination of a match, turning on the ambiguity indicator in the LUD, rolling back and retrying the transaction from a last syncpoint; and
in response to a determination of no match, setting the retry indicator and reissuing the LR.

2. The method of claim 1, wherein the LR further includes a lock resource name (LRN), and a lock status (LS).

3. The method of claim 1, wherein the CE routine further includes: in response to a determination that the requesting transaction does not hold other locks, keeping the LR pending and exiting the CE routine.

4. The method of claim 1, wherein the CE routine further includes: in response to a determination the LR is not a retry request, keeping the LR pending, and exiting the CE routine.

5. The method of claim 1, wherein reissuing the LR restarts the LR routine.

6. The method of claim 1, wherein:
the LR further includes a lock resource name (LRN), a lock status (LS);
the CE routine further includes: in response to a determination that the requesting transaction does not hold other locks, keeping the LR pending and exiting the CE routine;
the CE routine further includes: in response to a determination the LR is not a retry request, keeping the LR pending and exiting the CE routine; and
reissuing the LR restarts the LR routine.

7. A computer program product for preventing deadlocks in a mainframe computing system, the computer program product stored in a computer-readable storage medium, comprising program code that, when executed by the mainframe computing system, causes the computing system to perform actions comprising:
invoking a lock request (LR) routine, by a computer processor, in response to a LR from a requesting transaction, wherein a LR includes a lock has value (LHV), and lock user data (LUD), wherein the LR routine includes determining whether contention exists between the requesting transaction and one or more other transactions;
invoking a contention exit (CE) routine, by the computer processor, in response to a determination that contention exists; wherein the CE routine includes:
determining, by the computer processor, if the requesting transaction holds other locks;
in response to an affirmative determination that the requesting transaction holds other locks, determining, by the computer processor, if the LR is a retry request by checking if a retry indicator is set;
determining, by the computer processor, whether other lock contenders (LC) for the requested lock hold other locks; and
in response to an affirmative determination that the other LCs hold other locks, invoking, by the computer processor, a notify exit (NE) routine on each of the other LCs that hold other locks, wherein the NE routine includes:
placing a most current LHV for each of the other LCs that hold other locks in a notify exit user data (NEUD) if a transaction for each of the other LCs has a LR that has a same LHV of a LHV of the LR from the requesting transaction, and exiting the NE routine;
upon exiting the NE routine, invoking, by the computer processor, the CE routine a second time, wherein the CE routine further includes:
placing, by the computer processor, all LHVs from the NEUD in the LUD of the requesting transaction;
determining, by the computer processor, if there are more LHVs than can fit in the LUD of the requesting transaction; and
in response to an affirmative determination that there are more LHVs than can fit in the LUD of the requesting transaction, setting an ambiguity indicator in the LUD, denying the LR, and exiting the CE routine; and
upon exiting the CE routine for a second time, completing the LR routine, wherein the LR routine further includes:
determining, by the computer processor, whether the ambiguity indicator in the LUD is set;
in response to a determination that the ambiguity indicator in the LUD is not set, determining, by the computer processor, a match between a LHV the requesting transaction owns compared to the LHVs in the LUD of the requesting transaction;
in response to a determination of a match, turning on the ambiguity indicator
in the LUD, rolling back and retrying the transaction from a last syncpoint; and
in response to a determination of no match, setting the retry indicator and reissuing the LR.

8. The computer program product of claim 7, wherein the LR further includes a lock resource name (LRN), and a lock status (LS).

9. The computer program product of claim 7, wherein the CE routine further includes: in response to a determination that the requesting transaction does not hold other locks, keeping the LR pending and exiting the CE routine.

10. The computer program product of claim 7, wherein the CE routine further includes: in response to a determination the LR is not a retry request, keeping the LR pending, and exiting the CE routine.

11. The computer program product of claim 7, wherein reissuing the LR restarts the LR routine.

12. The computer program product of claim 7, wherein:
the LR further includes a lock resource name (LRN), a lock status (LS);
the CE routine further includes: in response to a determination that the requesting transaction does not hold other locks, keeping the LR pending and exiting the CE routine;
the CE routine further includes: in response to a determination the LR is not a retry request, keeping the LR pending and exiting the CE routine; and
reissuing the LR restarts the LR routine.

13. A deadlock prevention system comprising:
one or more processors;
one or more computer-readable storage media operably coupled to at least one of the processors; and
program instructions stored on the one or more computer-readable storage media for execution by at least one of the processors to cause the deadlock prevention system to perform the actions of:
invoking a lock request (LR) routine, by at least one of the processors, in response to a LR from a requesting transaction, wherein a LR includes a lock has value (LHV), and lock user data (LUD), wherein the LR routine includes determining whether contention exists between the requesting transaction and one or more other transactions;
invoking a contention exit (CE) routine, by at least one of the processors, in response to a determination that contention exists; wherein the CE routine includes:
determining, by at least one of the processors, if the requesting transaction holds other locks;
in response to an affirmative determination that the requesting transaction holds other locks, determining, by at least one of the processors, if the LR is a retry request by checking if a retry indicator is set;
determining, by at least one of the processors, whether other lock contenders (LC) for the requested lock hold other locks; and
in response to an affirmative determination that the other LCs hold other locks, invoking, by at least one of the processors, a notify exit (NE) routine on each of the other LCs that hold other locks, wherein the NE routine includes:
placing a most current LHV for each of the other LCs that hold other locks in a notify exit user data (NEUD) if a transaction for each of the other LCs has a LR that has a same LHV of a LHV of the LR from the requesting transaction, and exiting the NE routine;
upon exiting the NE routine, invoking, by at least one of the processors, the CE routine a second time, wherein the CE routine further includes:
placing, by at least one of the processors, all LHVs from the NEUD in the LUD of the requesting transaction;
determining, by at least one of the processors, if there are more LHVs than can fit in the LUD of the requesting transaction; and
in response to an affirmative determination that there are more LHVs than can fit in the LUD of the requesting transaction, setting an ambiguity indicator in the LUD, denying the LR, and exiting the CE routine; and
upon exiting the CE routine for a second time, completing the LR routine, wherein the LR routine further includes:
determining, by at least one of the processors, whether the ambiguity indicator in the LUD is set;
in response to a determination that the ambiguity indicator in the LUD is not set, determining, by at least one of the processors, a match between a LHV the requesting transaction owns compared to the LHVs in the LUD of the requesting transaction;
in response to a determination of a match, turning on the ambiguity indicator in the LUD, rolling back and retrying the transaction from a last syncpoint; and
in response to a determination of no match, setting the retry indicator and reissuing the LR.

14. The system of claim 13, wherein the LR further includes a lock resource name (LRN), and a lock status (LS).

15. The system of claim 13, wherein the CE routine further includes: in response to a determination that the requesting transaction does not hold other locks, keeping the LR pending and exiting the CE routine.

16. The system of claim 13, wherein the CE routine further includes: in response to a determination the LR is not a retry request, keeping the LR pending, and exiting the CE routine.

17. The system of claim 13, wherein reissuing the LR restarts the LR routine.

18. The system of claim 13, wherein:
the LR further includes a lock resource name (LRN), a lock status (LS);
the CE routine further includes: in response to a determination that the requesting transaction does not hold other locks, keeping the LR pending and exiting the CE routine;
the CE routine further includes: in response to a determination the LR is not a retry request, keeping the LR pending and exiting the CE routine; and
reissuing the LR restarts the LR routine.
